(19) United States
(12) Patent Application Publication
(10) Pub. No.: US 2026/0280033 A1
(43) Pub. Date: Sep. 17, 2026

(54) Battery Device and Battery System Having Same

(71) Applicant: SK ON CO., LTD., Seoul (KR)

(72) Inventors: Dong-Min KIM, Daejeon (KR); Dong-Ha HWANG, Daejeon (KR)

(21) Appl. No.: 19/167,938

(22) PCT Filed: Apr. 8, 2024
(86) PCT No.: PCT/KR2024/004590

§ 371 Date: Sep. 23, 2025

(30) Foreign Application Priority Data
Apr. 13, 2023 (KR) 10-2023-0048844

(51) Int. Cl. H01M 50/358; H01M 50/211; H01M 50/224; H01M 50/271; H01M 50/342; H01M 50/375; H01M 50/383; H01M 50/507

(52) U.S. Cl. CPC H01M 50/358; H01M 50/211; H01M 50/224; H01M 50/271; H01M 50/3425; H01M 50/375; H01M 50/383; H01M 50/507

(57) ABSTRACT

The present disclosure provides a battery device including: a cell assembly including multiple battery cells; a case including an accommodation space for accommodating the cell assembly; and at least one venting part formed in the case to discharge gas generated in the accommodation space to the outside, wherein the at least one venting part includes: a venting hole formed through a surface of the case to communicate with the accommodation space; a protruding part which is connected to the venting hole and has a shape protruding outward from the surface of the case; and an exhaust port formed through the protruding part, and the protruding part is integrally formed with the case.

### CROSS-REFERENCE TO RELATED APPLICATIONS

This application is National Stage a Entry of International Patent Application No. PCT/KR2024/004590, filed Apr. 8, 2024, which claims benefit and priority to Korean Patent Application No. KR 10-2023-0048844, filed Apr. 13, 2023, each of which is incorporated by reference in their entireties for all purposes.

### TECHNICAL FIELD

The present disclosure relates to a battery device including a cell assembly in which a plurality of battery cells are arranged, and a battery system including the same.

### BACKGROUND ART

Unlike primary batteries, secondary batteries may be recharged and discharged, and may thus be applicable to various fields such as digital cameras, mobile phones, laptops, hybrid vehicles, electric vehicles, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid prismatic or cylindrical can-type battery cells. Multiple battery cells may be formed into a stacked cell assembly.

The cell assembly may be disposed within a module housing to form a battery module, and multiple battery modules may be disposed within a pack housing to form a battery pack.

### DISCLOSURE OF INVENTION

### Technical Problem

Battery cells may ignite under a variety of events, including when the battery cell reaches the end of lifespan thereof, when the battery cell experiences swelling, when the battery cell is overcharged, when the battery cell is exposed to heat, when a sharp object such as a nail penetrates a case of the battery cell, when the battery cell is subjected to an external impact, and the like. If a cell assembly containing a battery cell ignites, flames or high-temperature gases (including electrolyte gases and combustible substances) emitted from the cell assembly may cause secondary ignition or a chain ignition in other adjacent cell assemblies. Furthermore, if flames generated from a battery module or battery pack are exposed to the outside, they may damage or destroy other components surrounding the battery module or battery pack, and may even lead to secondary ignition (a chain ignition) in other components.

An aspect of the present disclosure is to provide a battery device that delays or prevents the transfer of gases (including flames and combustible substances) generated in a cell assembly to other cell assemblies or components, and a battery system including the same.

An aspect of the present disclosure is to provide a battery device that delays or prevents secondary combustion and/or thermal runaway in a cell assembly, and a battery system including the same.

### Solution to Problem

According to an aspect of the present disclosure, a battery device may include a cell assembly including a plurality of battery cells; a case including an accommodation space accommodating the cell assembly; and at least one venting part formed in the case to discharge gas generated in the accommodation space to an outside, wherein the at least one venting part includes a venting hole formed on a surface of the case to communicate with the accommodation space, a protruding part connected to the venting hole and having a shape protruding outward from the surface of the case, and an exhaust port formed in the protruding part, and the protruding part is formed integrally with the case.

According to embodiments, the protruding part may be formed by press-working the case.

According to embodiments, the case may include a metal material, and the protruding part may include the same material of the case.

According to embodiments, the exhaust port may have a shape that is open in a second direction, different from a first direction, in which gas is discharged through the venting hole.

According to embodiments, the at least one venting part may include an exhaust space between the protruding part and the venting hole, communicating with the accommodation space, and the exhaust port may be formed at an end of the protruding part to communicate with the exhaust space. The exhaust space may have a shape in which a portion farther from the venting hole is narrower than a portion closer to the venting hole, based on a cross-section parallel to the exhaust port.

According to embodiments, the protruding part may include a guide surface extending from the surface of the case, and at least a portion of the guide surface may be inclined toward the exhaust port.

According to embodiments, the case may include a top plate covering an upper portion of the cell assembly and a side plate covering a side surface of the cell assembly, and the at least one venting part may be disposed on at least one of the top plate or the side plate.

According to embodiments, the at least one venting part may include a plurality of venting parts, and the plurality of venting parts may be configured such that respective exhaust ports face in the same direction.

According to embodiments, the plurality of venting parts may include first venting parts disposed in a row and second venting parts disposed in a row in a position spaced apart from the first venting parts.

According to embodiments, a first discharge direction in which the exhaust port of the first venting part is directed and a second discharge direction in which the exhaust port of the second venting part may be different directions to each other. The first discharge direction and the second discharge direction may be opposite directions.

According to embodiments, the first venting part and the second venting part may be disposed in at least one of the top plate or the side plate.

According to embodiments, the first venting part may be disposed in one of the top plate or the side plate, and the second venting part may be disposed in another of the top plate or the side plate.

According to embodiments, the battery device may further include a busbar assembly including a plurality of busbars electrically connecting the plurality of battery cells, and a connection terminal connecting at least some of the plurality of busbars to an outside, and the at least one venting part may be disposed such that the exhaust port does not face the connection terminal.

According to embodiments, the at least one venting part may include a sealing member that blocks the exhaust port, and the sealing member may be configured to open the exhaust port when a temperature or pressure becomes higher than or equal to a set temperature or higher than or equal to a set pressure.

According to embodiments, the battery device may include a blocking member disposed between the cell assembly and the at least one venting part and preventing flames from escaping through the venting part.

According to another aspect of the present disclosure, a battery device may include a cell assembly including a plurality of battery cells; a case including an accommodation space for accommodating the cell assembly; and at least one venting part formed in the case to discharge gas generated in the accommodation space to an outside, wherein each venting part includes a protruding part having a shape that protrudes outward from a surface of the case while covering a venting hole formed on the surface of the case, and an exhaust port formed in the protruding part, and the case includes a metal material, and the protruding part is formed integrally with the case by press-working the case.

According to another aspect of the present disclosure, a battery system may include a housing having an internal space; and a plurality of battery devices accommodated in the housing. Each of the plurality of battery devices includes a cell assembly including a plurality of battery cells; a case including an accommodation space accommodating the cell assembly; and at least one venting part formed in the case to discharge gas generated in the accommodation space to an outside, wherein the at least one venting part includes a venting hole formed on a surface of the case to communicate with the accommodation space, a protruding part connected to the venting hole and having a shape protruding outward from the surface of the case, and an exhaust port formed in the protruding part, wherein the protruding part is formed integrally with the case.

According to embodiments, the housing may include at least one gas passage through which gas flows, and the exhaust port may be disposed to face the at least one gas passage.

According to embodiments, the housing may include at least one gas exhaust part through which gas is discharged, and the exhaust port may be disposed in a direction to cause gas discharged from the exhaust port to flow toward the at least one gas exhaust part.

### Advantageous Effects of Invention

According to an embodiment of the present disclosure, by allowing the gas discharged through the venting part to have a directionality, the influence of the gas (including flames and combustion materials) generated from the cell assembly disposed within the battery device on the outside of the battery device may be reduced or prevented.

According to an embodiment of the present disclosure, secondary ignition and/or thermal runaway of the cell assembly may be delayed or prevented.

### BRIEF DESCRIPTION OF DRAWINGS

FIG. 1 is a perspective view of a battery device according to an embodiment of the present disclosure.

FIG. 2 is an exploded perspective view of the battery device illustrated in FIG. 1.

FIG. 3 is an exploded perspective view illustrating some components, such as a cell assembly, a busbar assembly, and the like illustrated in FIG. 2.

FIG. 4 is a cross-sectional view taken along line I-I′ of FIG. 1.

FIG. 5 is a cross-sectional view taken along line II-II′ of FIG. 1.

(a) of FIG. 6 and (b) of FIG. 6 are cross-sectional views illustrating modified examples of FIG. 5, where (a) of FIG. 6 illustrates a cross-sectional view taken along line I-I′ of FIG. 1, and (b) of FIG. 6 illustrates a cross-sectional view taken along line II-II′ of FIG. 1.

FIGS. 7 and 8 are cross-sectional views illustrating modified examples of FIG. 4, respectively.

FIG. 9 is an exploded perspective view illustrating a modified example of FIG. 3.

FIG. 10 is a cross-sectional view illustrating another modified example of FIG. 4, illustrating a cross-section of components illustrated in FIG. 9.

FIG. 11 is a perspective view of a battery device according to another embodiment of the present disclosure.

FIG. 12 is a cross-sectional view taken along line III-III′ of FIG. 11.

FIG. 13 is a cross-sectional view illustrating a modified example of FIG. 12.

FIG. 14 is a perspective view of a battery device according to another embodiment of the present disclosure.

FIG. 15 is a plan view of a battery system according to an embodiment of the present disclosure.

### BEST MODE FOR THE INVENTION

Before proceeding with a detailed description of the present disclosure, it should be noted that the terms and words used in this specification and claims should not be construed as limited to their conventional or dictionary meanings. Based on the principle that inventors may appropriately define terms and concepts to best describe their inventions, they should be interpreted in a way that aligns with the technical spirit of the present disclosure. Therefore, the embodiments described in this specification and the configurations depicted in the drawings represent only the most preferred embodiments of the present disclosure and do not fully represent the entire technical spirit of the present disclosure. Therefore, it should be understood that there may be various equivalents and modifications that may replace the same at the time of filing this application.

Hereinafter, preferred embodiments of the present disclosure will be described in detail with reference to the attached drawings. It should be noted that identical components are represented by possible identical reference numerals in the drawings. Furthermore, detailed descriptions of well-known functions and configurations that may obscure the gist of the present disclosure will be omitted. For the same reason, some components in the attached drawings are exaggerated, omitted, or schematically depicted, and the dimensions of respective components do not fully reflect the actual sizes.

In the present disclosure, a battery device (100) includes at least one cell assembly (110) that includes a plurality of battery cells (120) and is installed inside a case (150). In the present disclosure, the battery device (100) may include a battery module or a battery pack in which at least one cell assembly (110) is installed. In addition, in the present disclosure, the battery device (100) may include a battery pack having a cell-to-pack structure in which at least one cell assembly (110) is installed directly inside the case (150) without intervening a battery module. Hereinafter, for the convenience of explanation, a case in which the battery device is a battery module is described as an example, but the battery device according to an embodiment is also applicable to a battery pack.

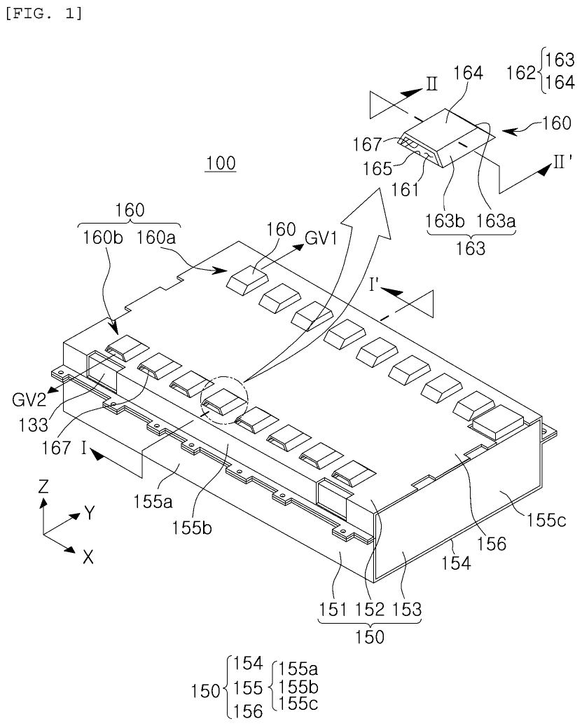

First, a battery device (100) according to an embodiment of the present disclosure will be described with reference to FIGS. 1 to 3.

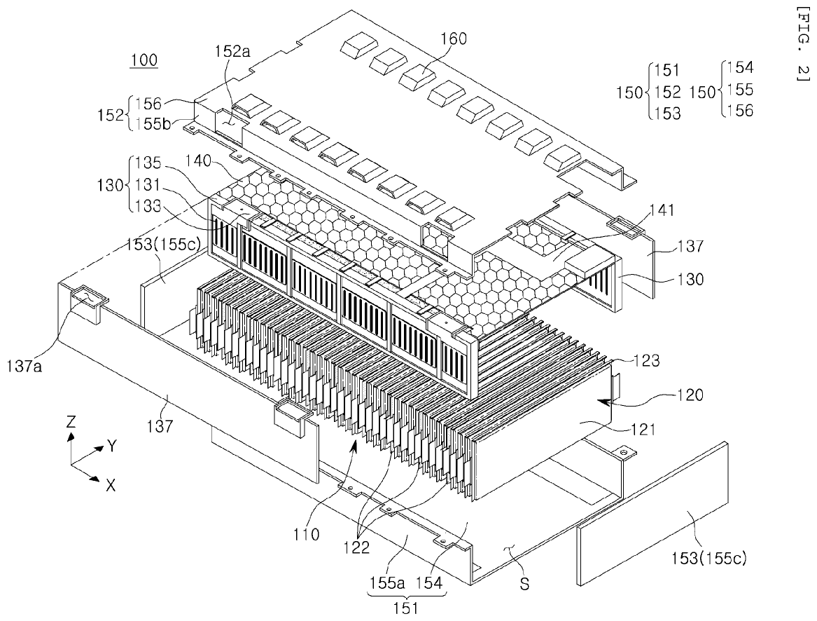

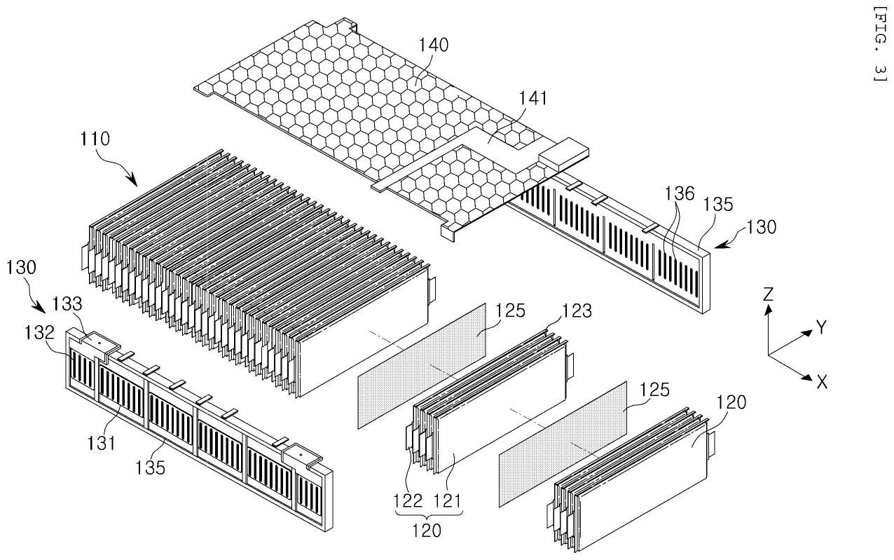

FIG. 1 is a perspective view of a battery device (100) according to an embodiment of the present disclosure, FIG. 2 is an exploded perspective view of the battery device (100) illustrated in FIG. 1, and FIG. 3 is an exploded perspective view illustrating some components, such as the cell assembly (110), the busbar assembly (130) and the like illustrated in FIG. 2. FIG. 3 illustrates a state in which battery cells (120) and insertion members (125) constituting the cell assembly (110) are stacked.

Referring to FIGS. 1 to 3, a battery device (100) according to an embodiment of the present disclosure may include a cell assembly (110), a case (150), and at least one venting part (160). Furthermore, a battery device (100) according to an embodiment of the present disclosure may include a busbar assembly (130).

The case (150) forms the exterior of the battery device (100) and protects the cell assembly (110) from the external environment. The case (150) may include an accommodation space (S) that accommodates at least one cell assembly (110).

The case (150) may include a bottom plate (154), a side plate (155), and a top plate (156). The bottom plate (154) corresponds to the bottom surface of the cell assembly (110), the top plate (156) corresponds to the top surface of the cell assembly (110), and the side plate (155) may correspond to multiple side surfaces of the cell assembly (110). The case (150) may form an accommodation space (S) surrounded by the bottom plate (154), the side plate (155), and the top plate (156). In FIGS. 1 and 2, the case (150) is depicted as covering all six sides of the accommodation space (S), but the case (150) may also have a shape in which at least one side of the accommodation space (S) is open.

The bottom plate (154), the side plate (155), and the top plate (156) may have at least a partially integrated shape. For example, the first case (151) may have a structure in which the bottom plate (154) and two first side plates (155a) extending upward from the bottom plate (154) are integrated. The second case (152) may have a structure in which the top plate (156) and two second side plates (155b) extending downward from the top plate (156) are integrated. In this case, the first case (151) and the second case (152) may each have a U-shaped cross-section. The first case (151) and the second case (152) may be coupled to each other to have a shape in which both ends are open. The first side plate (155a) and the second side plate (155b) may be coupled to each other through a known fastening means. The third case (153) may cover both open ends of the first case (151) and the second case (152). The third case (153) may cover the open portion when the first case (151) and the second case (152) are coupled. The third case (153) may form a third side plate (155c). The third case (153) may connect the top plate (156), the bottom plate (154), the first side plate (155), and the second side plate (155b). However, the cross-sectional shapes and division structures of the first case (151), second case (152), and third case (153) are not limited to the aforementioned structures and may be modified in various ways.

The side plate (155) may include a first side plate (155a) of the first case (151), a second side plate (155b) of the second case (152), and a third side plate (155c) of the third case (153).

The case (150) may be formed of a material with high thermal conductivity, such as metal. For example, the case (150) may be formed of aluminum. The case (150) may dissipate heat generated in the cell assembly (110) to the outside.

The cell assembly (110) may include a plurality of battery cells (120). The cell assembly (110) may have a form in which the plurality of battery cells (120) are stacked in one direction (X). Each battery cell (120) may output or store electrical energy.

The battery cell (120) may be composed of a lithium secondary battery, but is not limited thereto. For example, the battery cell (120) may be composed of various types of secondary batteries, such as a nickel-cadmium battery, a nickel-metal hydride battery, a nickel-hydrogen battery, or the like. The battery cell (120) may be composed of a pouch-type secondary battery. The following description will exemplify the use of a pouch-type secondary battery as the battery cell (120). However, the present disclosure does not exclude the use of a can-type secondary battery, such as a prismatic secondary battery or a cylindrical secondary battery, as the battery cell (120).

A battery cell (120) may include a cell body (121) that accommodates an electrode assembly, electrode leads (122), and a sealing portion (123). The cell body (121) provides an internal space for accommodating the electrode assembly and an electrolyte. The electrode assembly includes a plurality of electrode plates and electrode tabs and is housed within a pouch. The electrode plates are comprised of a cathode plate and an anode plate. The electrode assembly may have a stacked structure in which the cathode plate and the anode plate are stacked with a separator interposed therebetween, with wide surfaces of the cathode plate and the anode plate facing each other. Multiple cathode plates and multiple anode plates are respectively provided with electrode tabs. The electrode tabs may be connected to electrode leads (122) of the same polarity, by contacting each other with the same polarity. The electrode leads (122) may include a cathode lead connected to the cathode plate and an anode lead connected to the anode plate.

The sealing portion (123) forms a sealed space within the pouch by bonding at least portions of the perimeter of the cell body (121). The sealing portion (123) is formed in a flange shape extending outward from the cell body (121), which is formed in a container shape, and is disposed along the outer perimeter of the cell body (121). The sealing portion (123) may be formed through thermal fusion, but the method of forming the sealing portion (123) is not limited thereto.

The cell assembly (110) may include an insertion member (125) disposed between at least some of the battery cells (120) among the plurality of battery cells (120).

The insertion member (125) may include a compressible pad and/or an insulating member. The compressible pad may be compressed and elastically deformed when a specific battery cell (120) expands, thereby suppressing the overall volume of the cell assembly (110) from expanding. To this end, the compressible pad may be composed of polyurethane foam, but the material and structure thereof are not limited thereto.

The insulating member may block the spread of flame or high-temperature thermal energy between adjacent battery cells (120). Therefore, the insulating member may prevent a chain reaction of ignition within the cell assembly (110). The insulating member may include a material having at least one of flame retardancy, heat resistance, thermal insulation, or insulating properties. For example, the insulating member may include at least some of mica, silica, silicate, graphite, alumina, ceramic wool, and aerogel, which may prevent heat and/or flame propagation.

The busbar assembly (130) electrically connects the battery cells (120). The busbar assembly (130) may include a busbar (131) having electrical conductivity electrically connected to the electrode leads (122) of the battery cells (120) and an electrically insulating busbar frame (135).

The busbar assembly (130) may be coupled to one or both sides of the battery cell (120) where the electrode lead (122) is disposed. The busbar assembly (130) may be coupled to the electrode leads (122) in a direction (Y) perpendicular to the stacking direction (X) of the battery cells (120). The electrode leads (122) may penetrate the busbar frame (135). The electrode leads (122) are electrically connected in series and/or parallel form by the busbar (131) on the outside of the busbar frame (135). To this end, a coupling hole (132) through which the electrode lead (122) penetrates and is coupled thereto may be formed in the busbar (131). The coupling between the electrode lead (122) and the busbar (131) may be performed by welding in a state where the electrode lead (122) protrudes to the outside of the busbar (131) by penetrating through the coupling hole (132).

The busbar assembly (130) may be provided with a connection terminal (133) for electrical connection to the outside. Accordingly, the battery cell (120) may be electrically connected to the outside through the connection terminal (133). The connection terminal (133) may be exposed to the outside of the case (150) through an opening (152a) formed in the second case (152).

The busbar frame (135) is disposed between the cell body (121) of the battery cell (120) and the busbar (131) having electrical conductivity, thereby supporting the busbar (131). The busbar frame (135) may include a through hole (136) through which the electrode lead (122) passes. The electrode lead (122) may be electrically connected to the bus bar (131) by passing through the through hole (136) of the bus bar frame (135) and then being coupled to the coupling hole (132) formed in the bus bar (131).

To prevent the busbar assembly (130) and the case (150) from being electrically short-circuited, an insulating plate (137) may be disposed. The insulating plate (137) may be disposed between the busbar assembly (130) and the case (150) to face the busbar assembly (130). The insulating plate (137) may include an insulating material, thereby preventing the busbar assembly (130) and the case (150) from being electrically connected. For example, the insulating plate (137) may be formed of a plastic injection molded product including polypropylene, modified polyphenylene oxide (MPPO), or the like. However, the material of the insulating plate (137) is not limited thereto. By disposing the insulating plate (137), an electrical short-circuit between the cell assembly (110) and the case (150), or between the busbar (131) and the case (150) may be prevented from occurring. The insulating plate (137) may include a through hole (137a) through which a connection terminal (133) passes.

A circuit element (141) may be connected to the cell assembly (110) and/or the busbar assembly (130) to obtain temperature and/or voltage information from the cell assembly (110) and/or the busbar (131). The circuit element (141) may include a flexible printed circuit board (FPC) or a printed circuit board. A connection plate (140) may be disposed to install the circuit element (141). The connection plate (140) may be disposed on top of the cell assembly (110). The connection plate (140) may connect the busbar assemblies (130) at both ends of the cell assembly (110). The connection plate (140) may be composed of a material that combusts or melts at a preset temperature or higher in the case in which an event such as thermal runaway or the like occurs. The connection plate (140) may be formed of polypropylene, which burns and/or melts at approximately 160° C., or PVC, which burns and/or melts at approximately 170° C., but the material thereof is not limited thereto. However, the connection plate (140) is not an essential component, and the circuit member (141) may only be installed without the connection plate (140).

A venting part (160) may be formed in the case (150) to discharge gas generated in the accommodation space (S) within the case (150) to the outside. The venting part (160) may be formed in at least a portion of the top plate (156), side plate (155), and bottom plate (154).

At least one venting part (160) may be formed in the case (150). Multiple venting parts (160) may be provided in the case (150). Gas, combustion products, flames, or the like generated during an event may be discharged through the venting part (160), and in this specification, “gas” is defined to include combustion products and flames.

Each venting part (160) may include a venting hole (161) formed on the surface of the case (150) to communicate with the accommodation space (S), a protruding part (162) connected to (communicated with) the venting hole (161) and having a shape protruding outward from the surface of the case (150), and an exhaust port (167) formed in the protruding part (162). The protruding part (162) may have a shape or structure that covers at least a portion of the venting hole (161).

The protruding part (162) may be formed integrally with the case (150). For example, the protruding part (162) may be formed by press-working the case (150). When press-working the case (150), a protruding part (162) is formed in a portion of the case (150). According to an embodiment, since the protruding part (162) and the case (150) are formed integrally, the venting part (160) may be easily formed. The case (150) and the protruding part (162) may be formed of a metal material. The case (150) and the protruding part (162) may be formed of the same material.

At least a portion of the case (150) where the venting part (160) is formed may be formed of a metal material. For example, in the case in which the venting part (160) is formed in the top plate (156), the top plate (156) may be formed of a metal material. Additionally, in the case in which the venting part (160) is formed in the side plate (155), the side plate (155) may be formed of a metal material. Since the case (150) is formed of metal, heat generated within the accommodation space (S) within the case (150) may be easily dissipated to the outside of the accommodation space (S).

Furthermore, since the case (150) is formed of metal, the protruding part (162) may be easily formed by press-working a portion of the case (150). For example, a cut line (165) may be formed on the surface of the case (150) through cutting, punching or the like. Subsequently, by press-working the area corresponding to the protruding part (162) along the cut line (165) as the boundary, a protruding part (162) may be formed in the shape protruding on the surface of the case (150). The cut line (165) may form the boundary between the venting hole (161) and the exhaust port (167). In addition, after processing a plurality of cutting lines (165) on the surface of the case (150), it is also possible to process a plurality of protruding parts (162) simultaneously by press-working. Alternatively, it is also possible to first form the protruding part (162) by press-working the area corresponding to the protruding part (162) without forming the cutting line (165) in advance, and then form an exhaust port (167) on one side of the protruding part (162).

The protruding part (162) may include a guide surface extending from the surface of the case (150). The guide surface may guide gas generated within the accommodation space (S) to easily move from the venting hole (161) to the exhaust port (167). The protruding part (162) may include an extension surface (164) extending from the guide surface to be spaced apart from the venting hole (161).

At least a portion of the guide surface may be inclined. When the guide surface is inclined, the protruding part (162) may be easily formed during press-working.

At least a portion of the guide surface may be inclined toward the exhaust port (167). The guide surface may include a first inclined surface (163a) inclined toward the exhaust port (167) and a second inclined surface (163b) connecting the exhaust port (167) and the first inclined surface (163a). Since the first inclined surface (163a) is inclined toward the exhaust port (167), gas from the venting hole (161) may be easily discharged toward the exhaust port (167).

In FIGS. 1 and 2, the multiple venting parts (160) are illustrated as having the same size and shape. However, at least some of the multiple venting parts (160) may also have different sizes and shapes than the others.

The multiple venting parts (160) may be disposed in multiple rows. For example, the multiple venting parts (160) may include a first venting part (160a) and a second venting part (160b). The first venting part (160a) may be provided such that multiple venting holes (161), multiple protruding parts (162), and multiple exhaust ports (167) are disposed in a row. The second venting part (160b) may be provided such that multiple venting holes (161), multiple protruding parts (162), and multiple exhaust ports (167) are disposed in a row in a location spaced apart from the first venting part (160a). However, the number of rows formed by the multiple venting parts (160) is not limited to two, and may be one, or may also have values of three or more.

The first discharge direction (GV1) of the exhaust port (167) of the first venting part (160a) and the second discharge direction (GV2) of the exhaust port (167) of the second venting part (160b) may face different directions. In this case, the gas (including combustion materials and flames) discharged from the accommodation space (S) within the case (150) may be dispersed, thereby mitigating the phenomenon of the gas discharged from the multiple venting parts (160) being concentrated in a specific area.

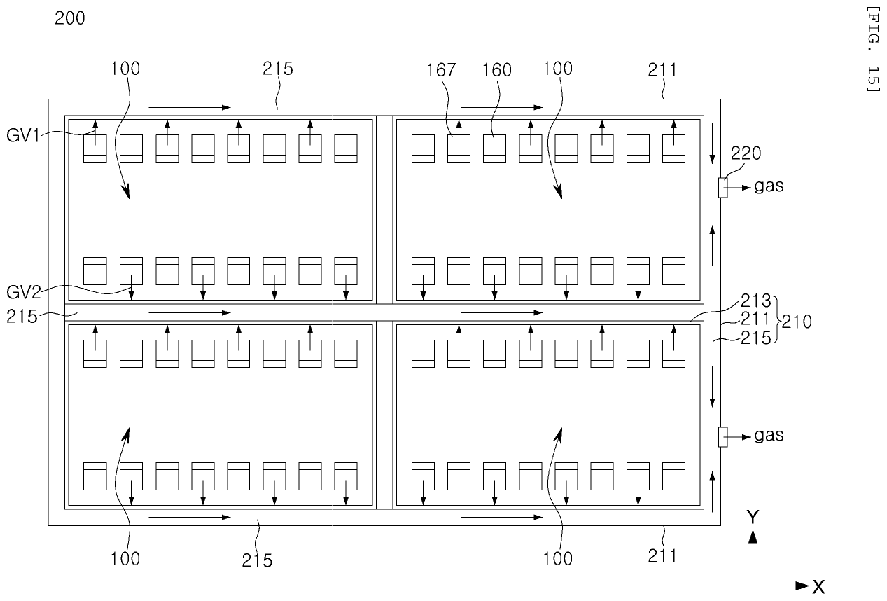

Alternatively, the first discharge direction (GV1) of the exhaust port (167) of the first venting part (160a) and the second discharge direction (GV2) of the exhaust port (167) of the second venting part (160b) may have the same direction. In this case, separate venting structures for the discharge of gas (including combustible materials and flames) may be formed in the first discharge direction (GV1) and the second discharge direction (GV2). For example, in the case in which the battery device (100) is a battery module housed within a battery pack (see 200 in FIG. 15), a separate venting structure (gas exhaust part) may be formed in the battery pack to allow gas discharged from the battery module to be discharged to the outside of the battery pack.

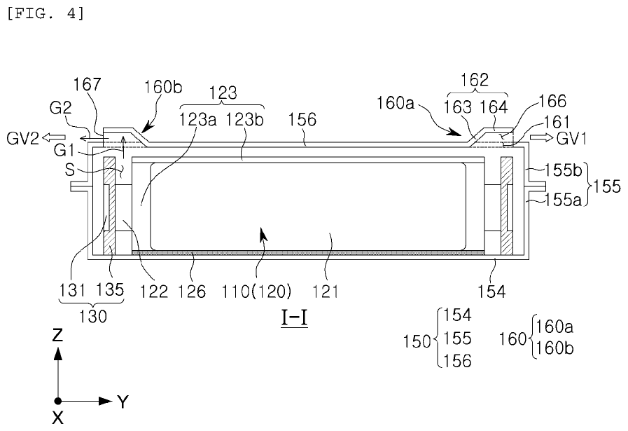

FIG. 4 is a cross-sectional view taken along line I-I′ of FIG. 1. For simplicity, only major components are illustrated in FIG. 4.

Referring to FIG. 4, the sealing portion (123) of the battery cell (120) may include a first sealing portion (123a) located in an area where the electrode lead (122) is disposed, and a second sealing portion (123b) located in an area where the electrode lead (122) is not disposed. In the embodiment of FIG. 4, the sealing portion (123) may not be formed on the lower surface of the battery cell (120).

If an event occurs in the battery cell (120), gas (including flames and combustion products) may be discharged through the sealing portion (123). Accordingly, the venting portion (160) may be disposed in an area adjacent to the sealing portion (123). For example, the venting portion (160) may be formed in the top plate (156).

The venting part (160) may include a venting hole (161), a protruding part (162), an exhaust space (166), and an exhaust port (167). The venting hole (161) is formed on the surface of the case (150) to communicate with the accommodation space (S) of the case (150). The protruding part (162) may have a shape protruding from a portion of the venting hole (161). The exhaust space (166) is formed between the protruding part (162) and the venting hole (161) and forms a space communicating with the accommodation space (S of FIG. 2) of the case (150). The exhaust port (167) may be formed at the end of the protruding part (162) to communicate with the exhaust space (166).

Gas generated in the accommodation space (S) may be discharged in a first direction (G1) through the venting hole (161) and then flow into the exhaust space (166). The gas entering the exhaust space (166) may then be discharged in a second direction (G2) toward the exhaust port (167). The gas entering the exhaust space (166) may be guided by the guide surface of the protruding part (162) and may be smoothly discharge in the second direction (G2).

The exhaust port (167) may have a shape that opens in a second direction (G2), different from the first direction (G1) in which gas is discharged through the venting hole (161). In the case of the related art without the protruding part (162) and the exhaust port (167), there is a problem in that the gas discharged through the venting hole (161) is discharged in a random direction. However, according to an embodiment, the exhaust port (167) is disposed to face the second direction (G2), so that the gas may be discharged with a directionality. Accordingly, the discharged gas may be easily controlled. For example, the gas discharged from the case (150) through a separate venting structure or gas treatment structure may be easily processed.

As illustrated in FIG. 4, the venting part (160) may be formed in the top plate (156). The venting part (160) may include a first venting part (160a) and a second venting part (160b) formed on the top plate (156). The gas discharged from the first venting part (160a) may be discharged in the first discharge direction (GV1), and the gas discharged from the second venting part (160b) may be discharged in the second discharge direction (GV2). The first discharge direction (GV1) and the second discharge direction (GV2) may have different directions. For example, the first discharge direction (GV1) and the second discharge direction (GV2) may have opposite directions to each other.

A cell assembly (110) including a plurality of battery cells (120) may be installed on a bottom plate (154). A heat transfer member (126) may be disposed between the cell assembly (110) and the bottom plate (154) so that heat generated in the cell assembly (110) may be easily dissipated through the bottom plate (154). One side of the heat transfer member (126) may be in contact with the lower surface of the battery cell (120), and the other side of the heat transfer member (126) may be in contact with the bottom plate (154). The heat transfer member (126) may be configured to include at least some of thermal grease, thermal adhesive, thermally conductive epoxy, and heat dissipation pads to ensure good heat transfer, but is not limited thereto. The heat transfer member (126) may be formed by being disposed as the form of a pad between the lower surface of the battery cell (120) and the top surface of the bottom plate (154), or by being applied in a liquid or gel form. The heat transfer member (126) may also be configured to have high insulation properties, and for example, a material with a dielectric strength in the range of 10 to 30 kV/mm may be used. In the case in which a highly insulating material is used as the heat transfer member (126), even if the insulation of the battery cell (120) is partially destroyed, insulation between the battery cell (120) and the case (150) may be maintained by the heat transfer member (126) disposed around the battery cell (120).

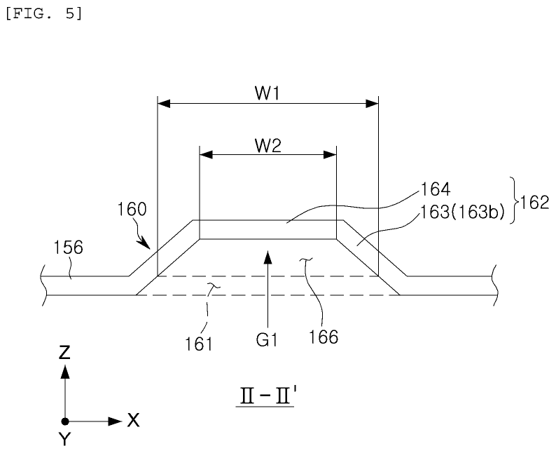

FIG. 5 is a cross-sectional view taken along line II-II′ of FIG. 1.

Referring to FIG. 5, when taking a cross-section parallel to the exhaust port (167 of FIG. 4) as the standard, the exhaust space (166) may have a shape in which a width (W2) of a portion farther from the venting hole (161) is narrower than a width (W1) of a portion closer to the venting hole (161). For example, the protruding part (162) may have an inclined surface (163) that slopes from the portion where the venting hole (161) is formed toward the extension surface (164). As the second inclined surface (163b) is inclined, the press-working of the protruding part (162) may be facilitated. In addition, the second inclined surface (163b) may guide gas introduced into the exhaust space (166) in the first direction (G1) to be easily discharged through the exhaust port (167 of FIG. 4).

(a) of FIG. 6 and (b) of FIG. 6 are cross-sectional views illustrating modified examples of FIG. 5. (a) of FIG. 6 illustrates a cross-section taken along line I-I′ of FIG. 1, and (b) of FIG. 6 illustrates a cross-section taken along line II-II′ of FIG. 1.

Referring to (a) of FIG. 6 and (b) of FIG. 6, the protruding part (162) may have an arcuate cross-section. In this case, the protruding part (162) may include a curved guide surface. Furthermore, as illustrated in (b) of FIG. 6, when considering a cross-section parallel to the exhaust port (167) as a reference, the exhaust space (166) may have a shape in which the width of the portion farther from the venting hole (161) is narrower than the width (W1) of the portion closer to the venting hole (161).

Even in the modified examples illustrated in (a) of FIG. 6 and (b) of FIG. 6, gas flowing into the exhaust space (166) through the venting hole (161) in the first direction (G1) may be guided by the guide surface of the protruding part (162) and smoothly discharged in the second direction (G2).

Meanwhile, as illustrated in (a) of FIG. 6, the venting part (160) may additionally include a sealing member (168) that blocks the exhaust port (167). The configuration of the sealing member (168) may be applied to other embodiments.

The sealing member (168) normally closes the exhaust port (167), thereby preventing external moisture or foreign substances from entering the accommodation space (S) of the case (150) through the exhaust port (167). The sealing member (168) may open the exhaust port (167) when the temperature or pressure is a set temperature or more or a set pressure or more.

The sealing member (168) may be composed of a material (e.g., synthetic resin) that combusts or melts at a preset temperature or higher when an event such as thermal runaway or the like occurs. For example, the sealing member (168) may be formed of polypropylene, which combusts and/or melts at approximately 160° C., or PVC, which combusts and/or melts at approximately 170° C., but the material is not limited thereto. As another example, the sealing member (168) may include a rupture plate that ruptures at a preset pressure or more.

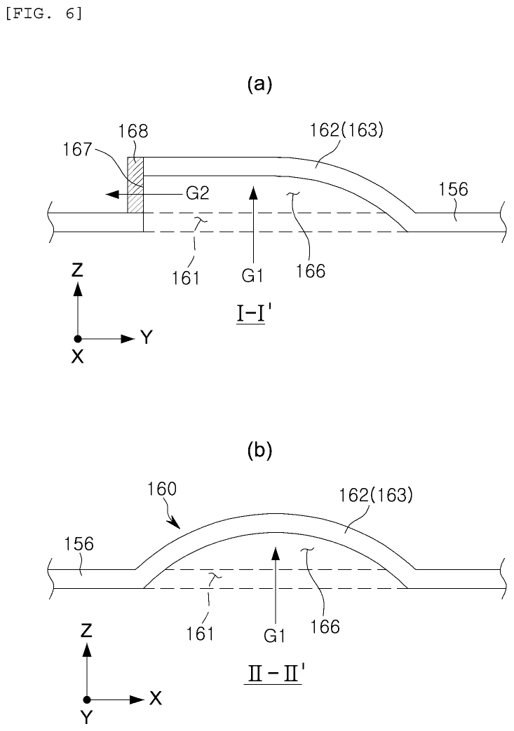

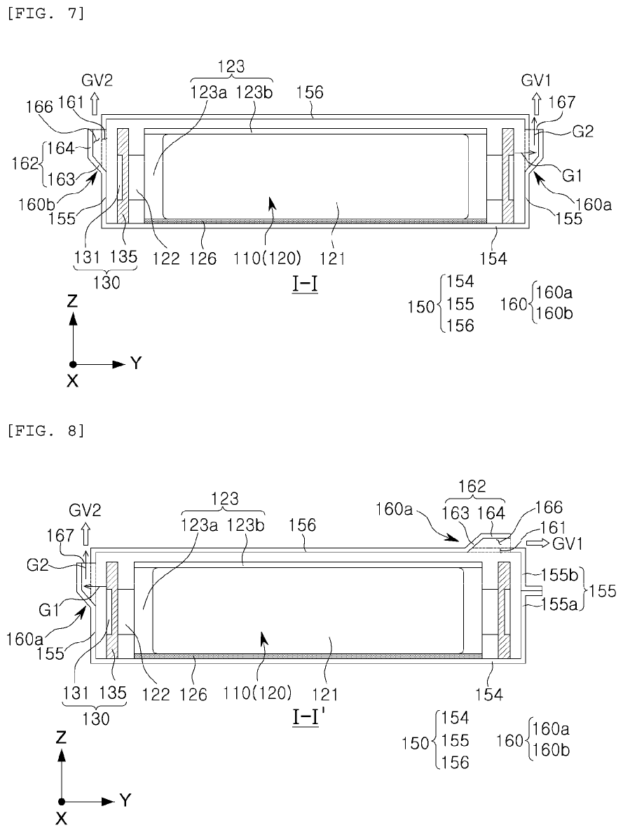

FIGS. 7 and 8 are cross-sectional views illustrating modified examples of FIG. 4, respectively.

As described in FIG. 4, in the case in which an event occurs in the battery cell (120), gas (including flames and combustion products) may be discharged through the sealing portion (123). Therefore, the venting part (160) may be disposed in an area adjacent to the sealing portion (123). The modified examples of FIGS. 7 and 8 differ from FIG. 4 only in the installation location and discharge direction of the venting part (160), and thus detailed descriptions will be omitted and only the differences will be described.

When the first sealing portion (123a) faces the side plate (155) and the second sealing portion (123b) faces the top plate (156), the first venting part (160a) and the second venting part (160b) may be disposed on at least one of the top plate (156) or the side plate (155).

In the embodiment illustrated in FIG. 7, the venting part (160) may be formed on at least one of the side plates (155). The first venting part (160a) may be formed on one side plate (155), and the second venting part (160b) may be formed on the other side plate (155) facing the first venting part (160a).

As illustrated in FIG. 7, the first discharge direction (GV1) toward which the exhaust port (167) of the first venting part (160a) faces and the second discharge direction (GV2) toward which the exhaust port (167) of the second venting part (160b) faces may have the same direction. For example, both the first discharge direction (GV1) and the second discharge direction (GV2) may face upward (+Z-axis). However, the first discharge direction (GV1) and the second discharge direction (GV2) are not limited thereto and may face downward, forward, or backward. Additionally, the first discharge direction (GV1) and the second discharge direction (GV2) may have different directions.

The venting part (160) may also be installed on both the top plate (156) and the side plate (155) adjacent to the sealing portion (123). For example, the first venting part (160a) may be disposed on one of the top plate (156) and the side plate (155), and the second venting part (160b) may be disposed on the other of the top plate (156) and the side plate (155).

In the embodiment illustrated in FIG. 8, the first venting part (160a) is formed on the top plate (156) and disposed such that the first discharge direction (GV1) faces the lateral direction (+Y axis). The second venting part (160b) is formed on the side plate (155) and disposed such that the second discharge direction (GV2) faces the upward direction (+Z axis).

However, the installation location, number of venting parts (160), and discharge direction may be varied to control the treatment of gas discharged from the case (150).

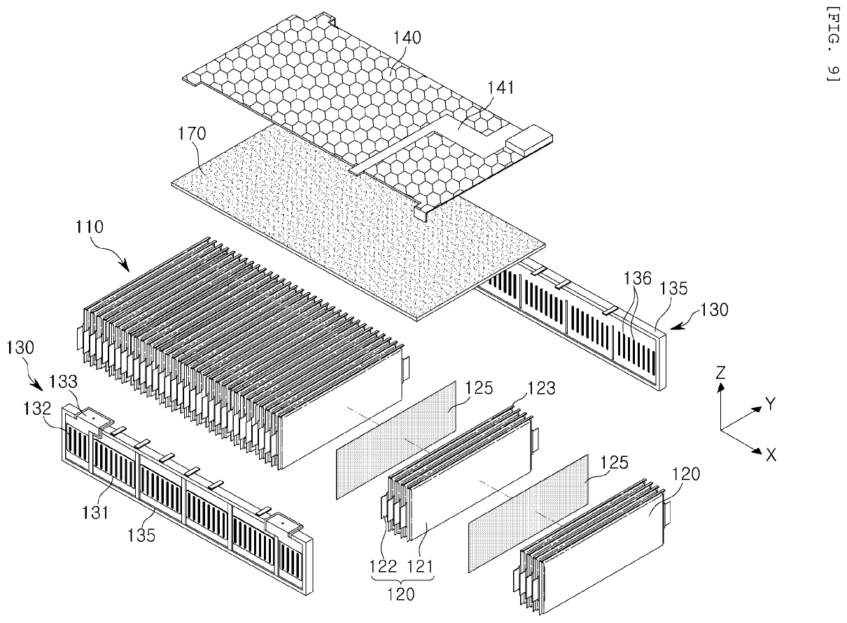

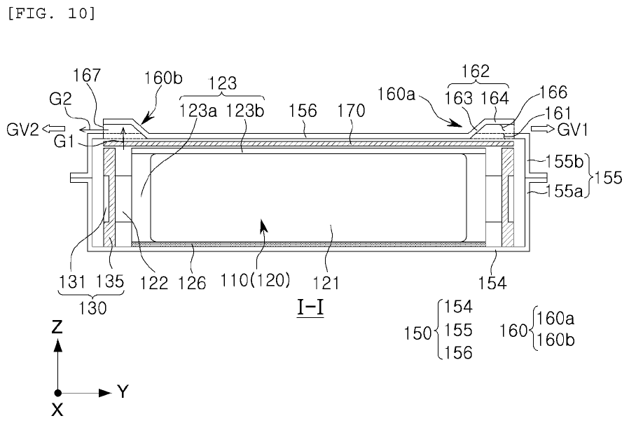

FIG. 9 is an exploded perspective view illustrating a modified example of FIG. 3, and FIG. 10 is a cross-sectional view illustrating another modified example of FIG. 4, showing the cross-section of the components illustrated in FIG. 9.

The embodiments of FIGS. 9 and 10 differ from the embodiments of FIGS. 3 and 4 only in that a blocking member (170) is disposed between the cell assembly (110) and the top plate (156). Therefore, detailed descriptions of identical or similar components will be omitted.

The blocking member (170) may be disposed between the cell assembly (110) and the venting part (160), thereby preventing flames from escaping through the venting part (160). The blocking member (170) may be disposed between the cell assembly (110) and the venting part (160), while facing the cell assembly (110). For example, as illustrated in FIGS. 9 and 10, the blocking member (170) may cover the upper side of the cell assembly (110).

The blocking member (170) may prevent or reduce flames generated in the accommodation space (S) from being exposed to the outside through the venting part (160). The blocking member (170) may include at least one of a porous metal foam or a metal mesh. The blocking member (170) may be formed of a flame-retardant or heat-resistant material. For example, the porous metal foam or metal mesh may include a metal material having a melting point of 1000° C. or higher.

In addition, the blocking member (170) may function as an insulating member, blocking flames or high-temperature thermal energy generated in the accommodation space (S) from being transmitted to the outside. The blocking member (170) used as an insulating material may include at least some of mica, silica, silicate, graphite, alumina, ceramic wool, and aerogel.

However, the material of the blocking member (170) is not limited to the aforementioned materials, and various known configurations may be used.

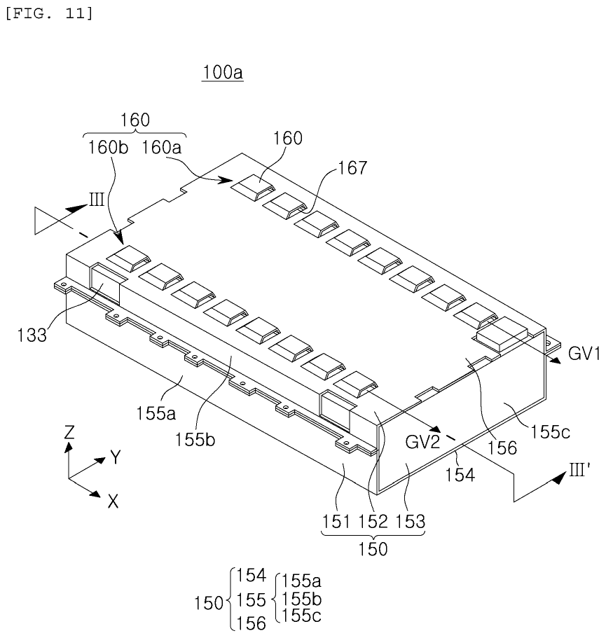

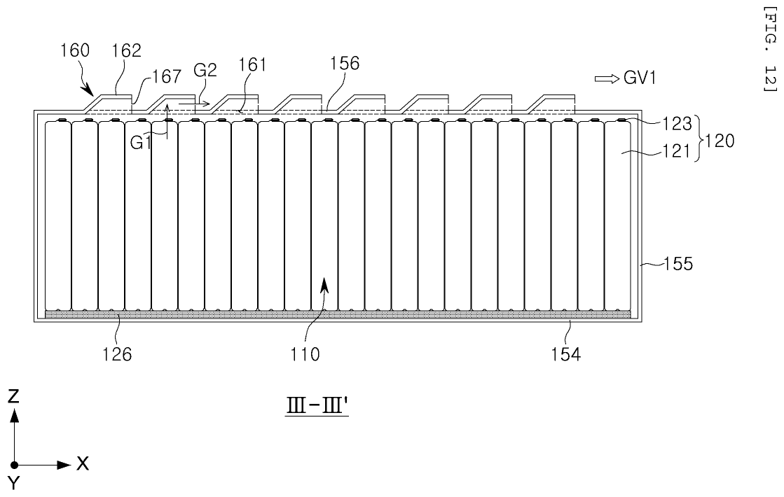

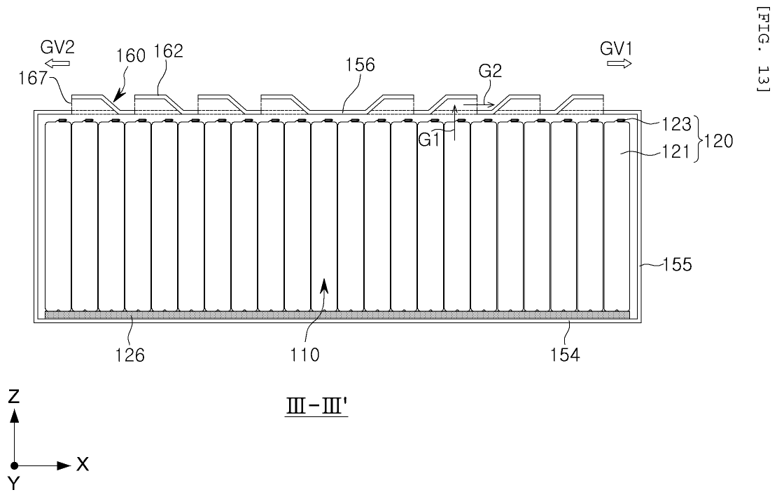

FIG. 11 is a perspective view of a battery device (100a) according to another embodiment of the present disclosure, FIG. 12 is a cross-sectional view taken along line III-III′ of FIG. 11, and FIG. 13 is a cross-sectional view illustrating a modified example of FIG. 12.

Embodiments illustrated in FIGS. 11 to 13 illustrate a configuration in which a venting part (160) is formed on the top plate (156), similarly to the embodiments illustrated in FIGS. 1 to 4. However, the embodiments illustrated in FIGS. 11 to 13 differ from the embodiments illustrated in FIGS. 1 to 4, in the discharge direction of the venting part (160).

Referring to FIGS. 11 and 12, the venting part (160) may include a first venting part (160a) having a first discharge direction (GV1) and a second venting part (160b) having a second discharge direction (GV2). The exhaust port (167) of the first venting part (160a) and the exhaust port (167) of the second venting part (160b) may be disposed to face the same direction (+X axis). Accordingly, the first discharge direction (GV1) of the first venting part (160a) and the second discharge direction (GV2) of the second venting part (160b) may face the same direction.

The embodiment illustrated in FIG. 13, unlike FIG. 12, depicts a configuration in which the first discharge direction (GV1) and the second discharge direction (GV2) are disposed in opposite directions.

In this way, the installation location, number of venting parts (160), and discharge direction may be varied to control the treatment of gas discharged from the case (150).

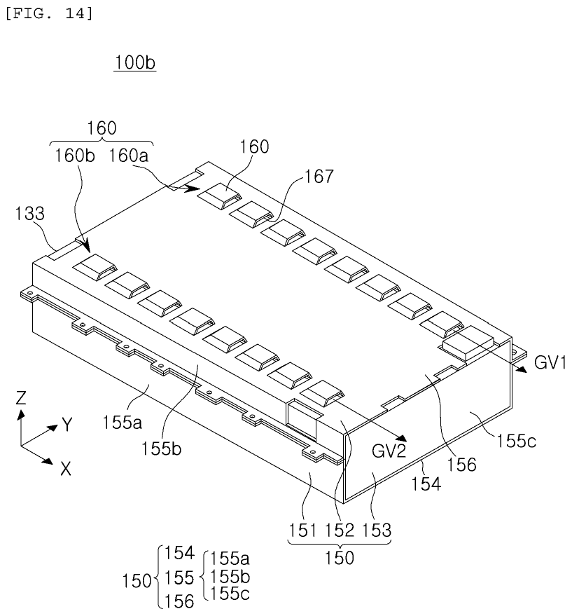

FIG. 14 is a perspective view of a battery device (100b) according to another embodiment of the present disclosure.

Compared to the embodiment illustrated in FIG. 11, an embodiment illustrated in FIG. 14 differs therefrom only in that the position at which the connection terminal (133) of the busbar assembly (130) is disposed is different.

The connection terminal (133) electrically connects the busbar (131) to external components (for example, other battery modules or electrical components). The connection terminal (133) is a terminal for high-voltage input/output, and a high-voltage busbar (131) may be connected to the connection terminal (133). The high-voltage busbar (131) electrically connects the connection terminal (133) to other external components.

As the gas discharged through the venting part (160) is high temperature, if this high temperature gas is discharged to the connection terminal (133) or the high-voltage bus bar (131), an additional fire may occur due to a short circuit or the like.

Therefore, as in the embodiment illustrated in FIG. 14, the venting part (160) may be disposed so that the exhaust port (167) does not face the connection terminal (133). The discharge direction of the venting part (160) may be in the opposite direction (+X) from where the connection terminal (133) is disposed.

FIG. 15 is a plan view of a battery system (200) according to an embodiment of the present disclosure.

As illustrated in FIG. 15, the battery system (200) may include a housing (210) having an internal space formed therein and multiple battery devices (100) housed in the housing (210).

While the battery system (200) of FIG. 15 illustrates the battery device (100) of FIG. 1 as an example, the battery system (200) according to an embodiment may include battery devices (100) of various structures described with reference to FIGS. 1 to 14. In the embodiment of FIG. 15, the battery system (200) may correspond to a battery pack, and the plurality of battery devices (100) may correspond to a battery module.

The housing (210) may include a side frame (211) disposed around the perimeter of the housing. The battery device (100) may be disposed within the internal space defined by the side frame (211). The housing (210) may include a cross frame (213) that partitions the internal space. The plurality of battery devices (100) may be respectively disposed within the space partitioned by the cross frame (213).

The housing (210) include at least one gas passage (215) through which gas discharged from the venting part (160) of the battery device (100) flows. The gas passage (215) may be disposed in at least a portion of the side frame (211) and the cross frame (213). The housing (210) may include a bottom frame disposed below the side frame (211) and a cover disposed above the side frame (211). The gas passage (215) may include a flow path passing through the bottom frame and/or the cover.

The exhaust port (167) of the venting part (160) may be disposed to face at least one gas passage (215) so that gas discharged from the venting part (160) may flow through the gas passage (215). For example, the exhaust port (167) may be disposed toward the gas passage (215) formed in the side frame (211) and/or cross frame (213). In this case, one venting part (160) may be disposed such that the exhaust port (167) faces the first discharge direction (GV1), and the other venting part (160) may be disposed such that the exhaust port (167) faces the second discharge direction (GV2). The first discharge direction (GV1) and the second discharge direction (GV2) may face opposite directions, but may also face the same direction.

The housing (210) include at least one gas exhaust part (220) through which gas is discharged. The gas exhaust part (220) may discharge gas generated within the housing (210) to the outside of the housing (210). The gas exhaust part (220) may be disposed to communicate with the gas passage (215). The gas exhaust part (220) may be installed on the side frame (211), but may also be installed on the cover or bottom frame. The installation location and number of gas exhaust parts (220) may be changed variously.

The gas exhaust part (220) may include a hole with an open structure. Alternatively, the gas exhaust part (220) may have a structure that opens when the pressure or temperature inside the housing (210) rises to a set value or more. The gas exhaust part (220) may include a valve that opens at a set pressure or set temperature or higher.

The exhaust port (167) of the battery device (100) may be disposed in a direction to allow gas discharged from the exhaust port (167) to flow to at least one gas exhaust part (220).

While the embodiments of the present disclosure have been described in detail above, the scope of the present disclosure is not limited thereto. Those skilled in the art will readily appreciate that various modifications and variations are possible without departing from the technical spirit of the present disclosure as defined in the claims.

For example, some components of the above-described embodiments may be omitted, and the respective embodiments may be implemented in combination with each other.

### DESCRIPTION OF REFERENCE CHARACTERS

100 . . . Battery device 110 . . . Cell assembly
120. Battery cell 130 . . . Busbar assembly
150. Case 154 . . . Bottom plate
155. Side plate 156 . . . Top plate
160. Venting part 160a . . . First venting part
160b. Second venting part 161 . . . Venting hole
162. Protruding part 167 . . . Exhaust port
168. Sealing member 170 . . . Blocking member
200 . . . Battery system 210 . . . Housing

1. A battery device comprising:
a cell assembly including a plurality of battery cells;
a case including an accommodation space accommodating the cell assembly; and
at least one venting part formed in the case to discharge gas generated in the accommodation space to an outside,
wherein the at least one venting part includes a venting hole formed on a surface of the case to communicate with the accommodation space, a protruding part connected to the venting hole and having a shape protruding outward from the surface of the case, and an exhaust port formed in the protruding part, and
the protruding part is formed integrally with the case.

2. The battery device of claim 1, wherein the protruding part is formed by press-working the case.

3. The battery device of claim 1, wherein the case includes a metal material, and
the protruding part includes the same material of the case.

4. The battery device of claim 1, wherein the exhaust port has a shape that is open in a second direction, different from a first direction in which gas is discharged through the venting hole.

5. The battery device of claim 1, wherein the at least one venting part includes an exhaust space between the protruding part and the venting hole, communicating with the accommodation space, and
the exhaust port is formed at an end of the protruding part to communicate with the exhaust space.

6. The battery device of claim 5, wherein the exhaust space has a shape in which a portion farther from the venting hole is narrower than a portion closer to the venting hole, based on a cross-section parallel to the exhaust port.

7. The battery device of claim 1, wherein the protruding part includes a guide surface extending from the surface of the case,
wherein at least a portion of the guide surface is inclined toward the exhaust port.

8. The battery device of claim 1, wherein the case includes a top plate covering an upper portion of the cell assembly and a side plate covering a side surface of the cell assembly, and
the at least one venting part is disposed on at least one of the top plate or the side plate.

9. The battery device of claim 8, wherein the at least one venting part includes a plurality of venting parts,
wherein the plurality of venting parts are configured such that respective exhaust ports face in the same direction.

10. The battery device of claim 8, wherein the at least one venting part includes a plurality of venting parts,
wherein the plurality of venting parts include first venting parts disposed in a row and second venting parts disposed in a row in a position spaced apart from the first venting parts.

11. The battery device of claim 10, wherein a first discharge direction in which the exhaust port of the first venting part is directed and a second discharge direction in which the exhaust port of the second venting part are different directions to each other.

12. The battery device of claim 11, wherein the first discharge direction and the second discharge direction are opposite directions.

13. The battery device of claim 10, wherein the first venting part and the second venting part are disposed in at least one of the top plate or the side plate.

14. The battery device of claim 10, wherein the first venting part is disposed in one of the top plate and the side plate, and the second venting part is disposed in another of the top plate or the side plate.

15. The battery device of claim 1, further comprising a busbar assembly including a plurality of busbars electrically connecting the plurality of battery cells, and a connection terminal connecting at least some of the plurality of busbars to an outside,
wherein the at least one venting part is disposed such that the exhaust port does not face the connection terminal.

16. The battery device of claim 1, wherein the at least one venting part includes a sealing member that blocks the exhaust port,
wherein the sealing member is configured to open the exhaust port when a temperature or pressure becomes higher than or equal to a set temperature or higher than or equal to a set pressure.

17. The battery device of claim 1, wherein the battery device includes a blocking member disposed between the cell assembly and the at least one venting part and preventing flames from escaping through the at least one venting part.

18. A battery system comprising:
a housing having an internal space; and
a plurality of battery devices accommodated in the housing,
wherein each of the plurality of battery devices includes,
a cell assembly including a plurality of battery cells;
a case including an accommodation space accommodating the cell assembly; and
at least one venting part formed in the case to discharge gas generated in the accommodation space to an outside,
wherein the at least one venting part includes a venting hole formed on a surface of the case to communicate with the accommodation space, a protruding part connected to the venting hole and having a shape protruding outward from the surface of the case, and an exhaust port formed in the protruding part,
wherein the protruding part is formed integrally with the case.

19. The battery system of claim 18, wherein the housing includes at least one gas passage through which gas flows, and
the exhaust port is disposed to face the at least one gas passage.

20. The battery system of claim 18, wherein the housing includes at least one gas exhaust part through which gas is discharged, and
the exhaust port is disposed in a direction to cause gas discharged from the exhaust port to flow toward the at least one gas exhaust part.
